(19) United States
(12) Patent Application Publication
(10) Pub. No.: US 2005/0083978 A1
(43) Pub. Date: Apr. 21, 2005

(54) Method for controlling laser beam power balance in laser scanning unit

(75) Inventor: Yong-kwon Kim, Cheonan-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/963,543

(22) Filed: Oct. 14, 2004

(30) Foreign Application Priority Data
Oct. 16, 2003 (KR) 2003-72270

(51) Int. Cl. H01S 3/13

(52) U.S. Cl. 372/29.021; 372/29.011; 372/38.01

(57) ABSTRACT

A method for controlling a laser beam power balance in a laser scanning unit is disclosed. The method of present invention comprises the steps of obtaining a first voltage value and a second voltage value corresponding to detection time points of a first laser beam and a second laser beam, respectively, emitted from the laser scanning unit. The first voltage value and the second voltage value are recorded in the laser scanning unit. After the laser scanning unit is mounted on a image forming apparatus, a third voltage value and a fourth voltage value are obtained corresponding to the detection time points of the first laser beam and the second laser beam, respectively, emitted from the laser scanning unit by driving the laser scanning unit mounted on the image forming apparatus. The third voltage value and the fourth voltage value are compared with the first voltage value and the second voltage value, respectively, thereby correcting the control voltage controlling the laser scanning unit by that variation.

### CROSS-REFERENCE TO RELATED APPLICATIONS

This application claims the benefit under 35 U.S.C. §119(a) of Korean Patent Application No. 2003-72270 filed Oct. 16, 2003, in the Korean Intellectual Property Office, the entire disclosure of which is incorporated herein by reference.

### BACKGROUND OF THE INVENTION

1. Field of the Invention

The present invention relates to a method for controlling laser beam power of a laser scanning unit. More particularly, the present invention relates to a method for controlling laser beam power balance in a multi-beam laser scanning unit.

2. Description of the Related Art

Generally, equipment such as a laser printer, a digital duplicator, and a multipurpose include a laser scanning unit for scanning laser beams on a photosensitive drum. The laser scanning unit comprises a laser diode for scanning a laser beam and a predetermined driving circuit for driving the laser diode. On the other hand, in order to increase the number of electrostatic latent images, which are formed by the laser scanning unit on the photosensitive drum per unit hour, a technology has been developed which increases the number of laser beams emitted from the laser scanning unit. The laser scanning unit to which the technology is applied is commonly referred to as a multi-beam laser scanning unit. The multi-beam scanning unit can improve the speed of printing of the printer or increase the speed of copying of the digital duplicator by simultaneously scanning at least two or more laser beams on the photosensitive drum. But it has a disadvantage of degrading the printing quality of the printer or the duplicator if the optical power between the respective laser beams scanned onto the photosensitive drum from each of the laser diodes is different.

Referring to FIG. 1, the laser beam power automatic adjusting circuit comprises a laser diode (LD) 10 for scanning a laser beam on a photosensitive drum (not shown), a photodiode 11 connected in parallel with the laser diode 10 and sensing the optical power of the laser beam scanned onto the photosensitive drum from the laser diode 10. Additionally, transistors 12, 13 and resistors 14, 15 control the voltage applied to the laser diode 10 depending on the result sensed by the photodiode 11. The shown capacitors 16, 17 remove any ripple voltage included in a power supply voltage (Vcc) and constantly sustain the potential level of the power supply voltage (Vcc).

First of all, when the laser diode 10 is applied with the power supply voltage (Vcc), the laser diode 10 outputs a prescribed level (typically in a range between a few μW and tens of μW) of laser beam. At this time, the photodiode 11 responds to the laser beam emitted from the laser diode 10 and applies a predetermined current value to the base terminal of transistor 13, which turns on transistor 13. With the transistor 13 being turned-on, the power supply voltage (Vcc) is applied to the base terminal of transistor 12, whereby transistor 12 is turned-on. According to this, an anode terminal and a cathode terminal of the laser diode 10 form a current path between the power supply voltage (Vcc) and a ground terminal. At this time, the voltage between the anode terminal and the cathode terminal of the laser diode 10 is varied by the resistor 15 and the variable resistor 14 disposed between the base terminal of the transistor 13 and the ground terminal. Thus, the optical power of the laser beam, which is scanned onto the photosensitive drum (not shown) from the laser diode 10, is adjusted. In other words, by adjusting the variable resistor 14, it is possible to control the optical power of the laser beam scanned onto the photosensitive drum (not shown) from the laser diode 10. As such, a circuit which controls voltage applied to the laser diode 10 and the optical power of the laser beam scanned onto the photosensitive drum (not shown) from the laser diode 10 is typically referred to as a Auto Power Control (APC). The manufacturer of the laser printer or the digital duplicator controls the optical power of the laser beams by manually operating the variable resistor 14. However, there is variation in the optical power of the laser beams in each machine because the control of the optical power is set by a manual operation. The manual operation does not take into account the characteristics of the laser diode and the characteristics of the image forming apparatus having the laser scanning unit mounted therein. Furthermore, time is lost because adjusting the optical power of the laser beam is a manual operation. Therefore, there are problems in the print quality of an individual image forming apparatus having the manually operated laser scanning unit mounted due to unevenness. Additionally, the variation in the optical power between the scanned laser beams degrades the print quality of the printer or the duplicator in the case of a multi-beam laser scanning unit wherein multiple laser beams are scanned onto the photosensitive drum from the laser scanning unit.

### SUMMARY OF THE INVENTION

The present invention solves the above drawbacks and other problems associated with the conventional arrangement. An aspect of the present invention is to provide a method for controlling laser beam power balance in a laser scanning unit wherein the optical power of the laser beam output from the laser scanning unit is automatically controlled. Also, it is a further object of the present invention to provide a method for controlling the laser beam power balance in a multi-beam laser scanning unit which controls the optical power balance between the plurality of laser beams output from the multi-beam laser scanning unit.

The object of the present invention is accomplished by a method for controlling the laser beam power balance in a laser scanning unit comprising the steps of obtaining a first voltage value corresponding to a detection time point of the laser beam power emitted from the laser scanning unit and recording the first voltage value in the laser scanning unit. After the laser scanning unit is mounted on an image forming apparatus, a second voltage value is obtained corresponding to the detection time point of the laser beam power emitted from the laser scanning unit by driving the laser scanning unit mounted on the image forming apparatus. The second voltage value is compared with the first voltage value allowing a corrected control voltage to control the laser scanning unit by the amount of variation.

Preferably, the step of correcting the control voltage of the laser scanning unit is carried out by the following formula:
Rb′=Rb−(Ra−Ra′)
wherein, the variable Rb′denotes a control voltage value corresponding to a corrected control voltage. The variable Rb denotes a control voltage value corresponding to a control voltage applied to the laser scanning unit before the correction. The variable Ra denotes a control voltage value corresponding to a laser beam power detection voltage previously stored in the laser scanning unit. Finally, the variable Ra′ denotes a control voltage value corresponding to a control voltage at the time of detecting the laser beam power emitted from the laser scanning unit after the laser scanning unit is mounted on the image forming apparatus.

It is desirable that the step of correcting the control voltage of the laser scanning unit further comprises the step of processing an error when a difference between the first voltage value and the second voltage value exceeds a predetermined error range.

Another object of the present invention is accomplished by a method for controlling the laser beam power balance in a laser scanning unit comprising the steps of obtaining a first voltage value and a second voltage value corresponding to detection time points of a first laser beam and a second laser beam, respectively, emitted from the laser scanning unit. The first voltage value and the second voltage value are recorded in the laser scanning unit. After the laser scanning unit is mounted on an image forming apparatus, a third voltage value and a fourth voltage value are obtained corresponding to the detection time points of the first laser beam and the second laser beam, respectively, emitted from the laser scanning unit by driving the laser scanning unit mounted on the image forming apparatus. The third voltage value and the fourth voltage value are compared to the first voltage value and the second voltage value, respectively. The result of the comparison allows for correcting a control voltage controlling the laser scanning unit by that variation.

Preferably, the step of correcting the control voltage of the laser scanning unit is carried out by the following formula:
Rb′=Rb−(Ra−Ra′) <Formula 1>
wherein, the variable Rb′ denotes a control voltage value corresponding to a corrected control voltage. The variable Rb denotes a control voltage value corresponding to a control voltage applied to the laser scanning unit before the correction. The variable Ra denotes a control voltage value corresponding to a laser beam power detection voltage previously stored in the laser scanning unit. The variable Ra′ denotes a control voltage value corresponding to a control voltage at the time of detecting the laser beam power emitted from the laser scanning unit after the laser scanning unit is mounted on the image forming apparatus.

Alternatively, it is desirable that the step of correcting the control voltage of the laser scanning unit further comprises the step of processing errors when a difference between the first voltage value and the third voltage value and a difference between the second voltage value and the fourth voltage value exceed a predetermined error range.

Another object of the present invention is accomplished by a method for controlling a laser beam power balance in a laser scanning unit comprising the steps of obtaining a first voltage value and a second voltage value corresponding to detection time points of a first laser beam and a second laser beam, respectively, emitted from the laser scanning unit. A third voltage value and a fourth voltage value are obtained corresponding to time points the first laser beam and the second laser beam reach a target laser beam power. These voltage values are recorded in the laser scanning unit. After the laser scanning unit is mounted on an image forming apparatus, a first function is calculated having a prescribed gradient based on the obtained first and second voltage values. A second function is calculated having a prescribed gradient based on the obtained third and fourth voltage values. The preferred initial values for the first and second functions is the voltage values corresponding to the detection time points of the respective laser beams emitted from the laser scanning unit mounted on the image forming apparatus.

Preferably, the step of applying the first function and the second function is carried out by the following formula:
Rb′=Rb+f(Ra, Ra′),
wherein, the variable Rb′ denotes a control voltage value corresponding to a corrected control voltage. The variable Rb denotes a control voltage value corresponding to a control voltage applied to the laser scanning unit before the correction. The variable Ra denotes a control voltage value corresponding to a laser beam power detection voltage previously stored in the laser scanning unit. The variable Ra′ denotes a control voltage value corresponding to a control voltage at the time of detecting the laser beam power emitted from the laser scanning unit after the laser scanning unit is mounted on the image forming apparatus. The function f(Ra, Ra′) denotes a function calculated based on the first voltage value and the third voltage value or a function calculated based on the second voltage value and the fourth voltage value.

### BRIEF DESCRIPTION OF THE DRAWINGS

The above aspects and features of the present invention will be more apparent by describing certain embodiments of the present invention with reference to the accompanying drawings, in which:

FIG. 1 illustrates a conventional laser beam power automatic adjusting circuit of the prior art laser scanning unit;

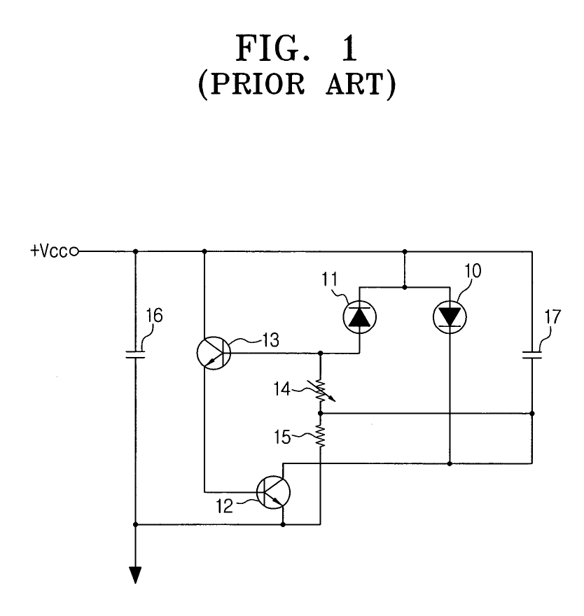

FIG. 2 is a view for explaining a method for controlling laser beam power balance in the laser scanning unit according to an embodiment of the present invention;

FIG. 3 is a detailed block diagram illustrating the laser scanning unit shown in FIG. 2 according to an embodiment of the present invention;

FIG. 4 is a graph illustrating an exemplary electric characteristic variation occurring after the laser scanning shown in FIG. 2 is mounted on the image forming apparatus according to an embodiment of the present invention;

FIG. 5 is a view illustrating an example of the laser printer on which the laser scanning shown in FIG. 2 is mounted according to an embodiment of the present invention;

FIG. 6 is a flowchart of a method for controlling laser beam power balance in the laser scanning unit according to an embodiment of the present invention;

FIG. 7 is a flowchart illustrating a method for controlling the laser beam power balance between a first laser diode and a second laser diode included in a laser scanning unit having information on an emission commence voltage which is mounted on an image forming apparatus according to an embodiment of the present invention; and

FIG. 8 is a flowchart illustrating another method for controlling the laser beam power balance between a first laser diode and a second laser diode included in a laser scanning unit having information on an emission commence voltage which is mounted on an image forming apparatus according to an embodiment of the present invention.

In the drawing figures, it will be understood that like reference numerals refer to like features and structures.

### DETAILED DESCRIPTION OF THE PREFERRED EMBODIMENTS

Certain embodiments of the present invention will now be described in greater detail with reference to the accompanying drawings.

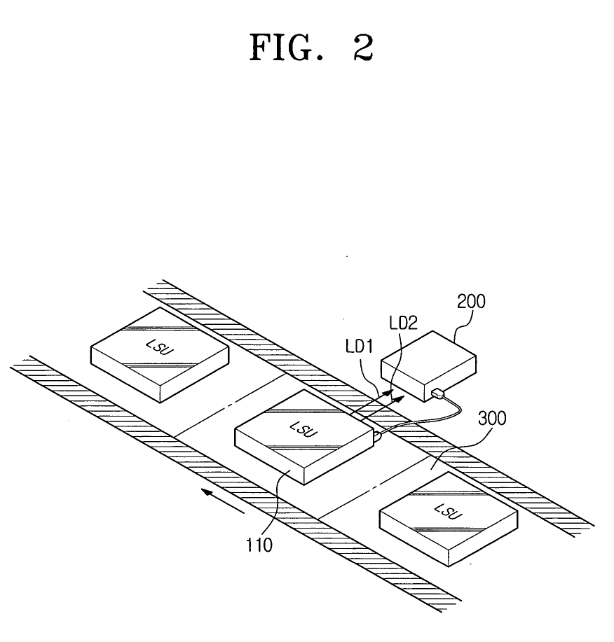

The matters defined in the description such as a detailed construction and elements are provided to assist in a comprehensive understanding of the invention. Thus, for the sake of clarity, detailed descriptions of well-known functions or constructions are omitted. As shown in FIG. 2, the method for controlling laser beam power balance in the laser scanning unit according to an embodiment of the present invention comprises the step of measuring the optical outputs of a first laser beam LD1 and a second laser beam LD2 emitted from a laser scanning unit (LSU) 110. The optical output is measured by a laser beam power meter 200 before mounting the laser scanning unit 110 on the image forming apparatus. Additionally, the step of feeding back a voltage value corresponding to the measured optical power to the laser scanning unit 110 to store the voltage value in the laser scanning unit 110, which results in each of the laser scanning units 110 having information on a unique electric characteristic of the respective LSU. At this time, the laser scanning unit 110 stores the control voltage values applied to laser diodes (not shown) emitting the respective laser beams LD1 and LD2 when the respective laser beams LD1 and LD2 are initially emitted. A control voltage value at the time the respective laser beams LD1 and LD2 reach a desired optical power is also stored in the laser scanning unit 110. That is, the electrical characteristics of the laser scanning unit 110 is preferably detected while the laser scanning unit 100 is on a conveyor 300 before the laser scanning unit 110 is mounted on the image forming apparatus such as a laser printer or a digital duplicator.

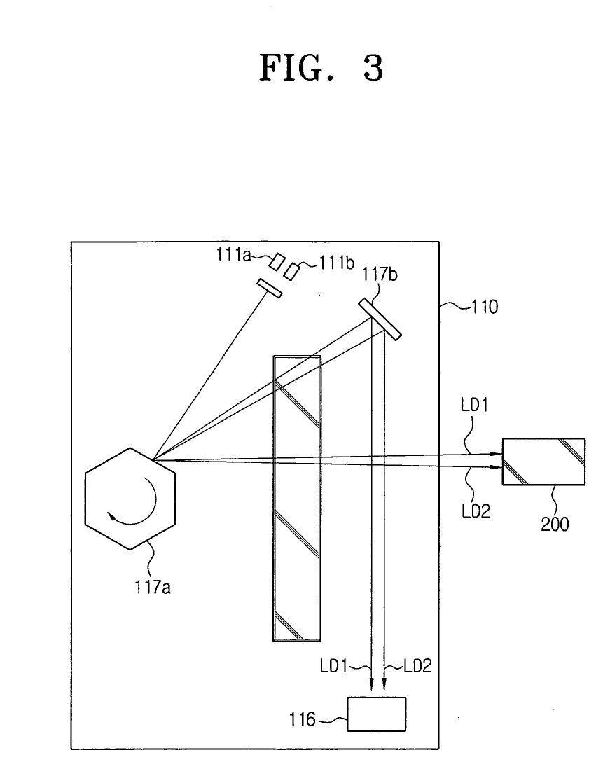

As shown in FIG. 3, the laser scanning unit 110 comprises a first laser 111a and second laser diode 111b, a polygon mirror 117a, a laser beam detection section 116 and another mirror 117b. The first laser diode 111a and second laser diode 111b respectively emit a first laser beam LD1 and a second laser beam LD2. A polygon mirror 117a reflects the first laser beam LD1 and the second laser beam LD2. The laser beam detection section 116 senses the emissions of the first laser beam LD1 and the second laser beam LD2 reflected by the polygon mirror 117a, and mirror 117b deflects the first laser beam LD1 and the second laser beam LD2 reflected by the polygon mirror 117a into the laser beam detection section 116. The time points at which the first laser beam LD1 and a second laser beam LD2 are initially emitted from the laser scanning unit 110 are attained by the laser beam detection section 116 included in the laser scanning unit 110. When each of the first laser beam LD1 and a second laser beam LD2 reaches the desired optical power (for example, 400 μW) as measured by the laser beam power meter 200, the laser beam power meter 200 signals the laser scanning unit 110. Then, the laser scanning unit 110 can detect the time points the first laser beam LD1 and a second laser beam LD2 that are initially emitted. The laser scanning unit 110 also detects the control voltages applied to a first and second laser diodes 111 and 112 when each of the first laser beam LD1 and a second laser beam LD2 reaches the desired optical power.

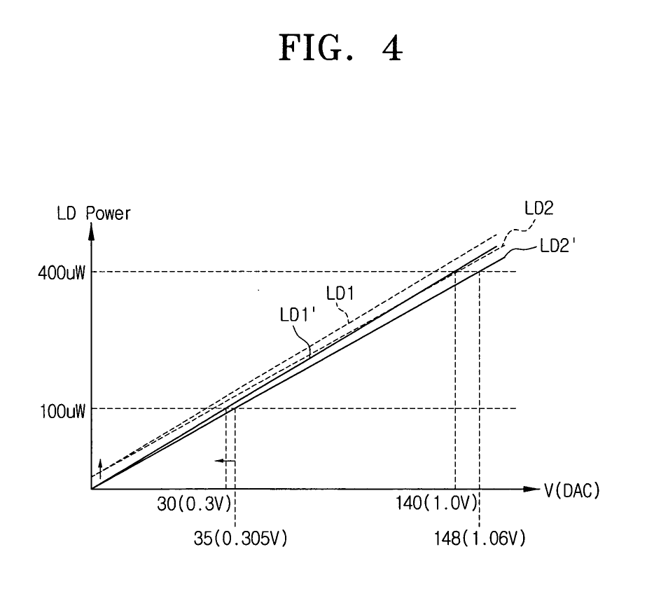

As shown in FIG. 4, after the laser scanning unit 110 is mounted on the image forming apparatus such as a laser printer or a digital duplicator, the laser scanning unit 110 is affected by the electrical characteristics of the image forming apparatus, thereby having different characteristics from the initial electrical characteristics. Reference numerals LD1 and LD2 each shows an exemplary electrical characteristic graph of the laser scanning unit 110. Reference numerals LD1′ and LD2′ each shows an exemplary output characteristic of each of a first laser beam LD1 and a second laser beam LD2 emitted from the laser scanning unit 110 when the laser scanning unit 110 is mounted on the image forming apparatus (not shown). This is due to the variation in the power supply from the image forming apparatus, the effects of the peripheral components included in the image forming apparatus, and the variation in other surrounding environments. Accordingly, the present invention detects the electrical characteristics of the laser scanning unit 110 and the characteristic variation at the time the laser scanning unit 110 is mounted on the image forming apparatus and corrects the corresponding variation, thereby correcting the optical power balance between the laser beams LD1 and LD2 emitted from the laser scanning unit 110.

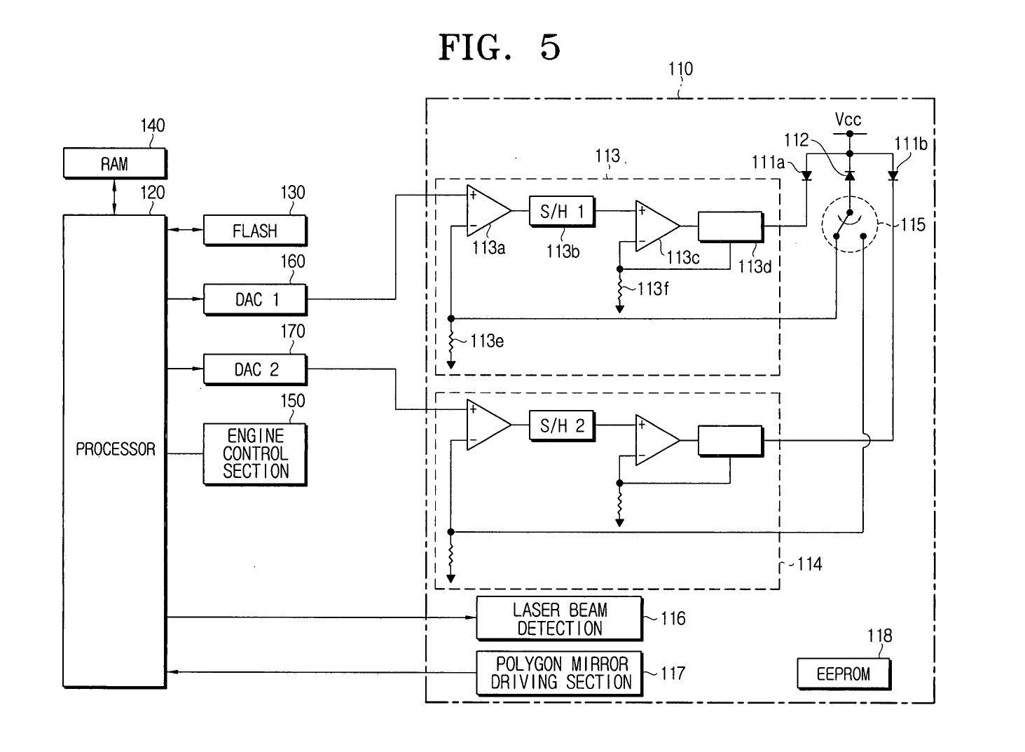

The laser printer shown in FIG. 5 comprises a laser scanning unit 110, a processor 120, flash ROM 130, RAM 140, an engine control section 150, a first digital-to-analogue converter (DAC) 160, and a second digital-to-analogue converter (DAC) 170.

The laser scanning unit 110 scans laser beams onto a photosensitive drum (not shown) to form an electrostatic latent image on the photosensitive drum. In the drawing, while there is shown a multi-beam laser scanning unit 110 scanning two laser beams, it should be noted that the present invention may be applied to a laser beam scanning unit scanning more than one laser beams other than the multi-beam laser scanning unit shown.

The processor 120 generally controls the laser printer. It also converts the printing data applied from an information processing unit such as a personal computer (not shown) into data having a bitmap format, and supplies the converted data to the engine control section 150. Further, the processor 120 controls the first DAC 160 and the second DAC 170, which controls the laser beam power of laser diodes 11a and 111b, based on the voltage values corresponding to the time point at which the laser beams LD1 and LD2 are emitted from the laser scanning unit 110 and the time point at which the laser beams LD1 and LD2 reach a desired optical power.

The flash ROM 130 preferably stores various programs for controlling the laser printer and for converting data when the processor 120 converts the printing data into the data having bitmap format. Further, the flash ROM 130 preferably stores control voltage information in look-up table. The stored control voltage information is the information regarding the control voltage applied to laser scanning unit 110, the stored control voltage information selected by the processor 120, and applied to the first DAC 160 and the second DAC 170, respectively. The first DAC 160 and the second DAC 170 perform digital-to-analogue conversion on the control voltage information applied by the processor 120 to generate a prescribed control voltage, and apply the generated control voltage to the laser scanning unit 110.

The RAM 140 preferably provides temporary storage for the processor 120 when converting the printing data sent to the processor 120 into a bitmap data format. RAM 140 can also be used as a temporary storage for the control data which the processor 120 needs in controlling the laser printer. The engine control section 150 controls the operations of various motors, actuators, and other machining components included in the laser printer in response to the data having bitmap format outputted from the processor 120.

If the first DAC 160 and the second DAC 170 receive the control voltage information from the processor 120, the first DAC 160 and the second DAC 170 output a corresponding analogue voltage and apply it to the laser scanning unit 110.

The relationship between the control voltage value applied to the first DAC 160 and the second DAC 170 and the analogue voltage output in response to the control voltage value is as follows:

TABLE 1

| | | | | | | | |
|---|---|---|---|---|---|---|---|
| first or | 0 | . . . | 30 | 35 | . . . | 140 | 148 |
| second | | | | | | | |
| DAC | | | | | | | |
| Control | 0 V | . . . | 0.3 V | 0.305 V | . . . | 1 V | 1.06 V |
| voltage(V) | | | | | | | |

Table 1 shows an example of the relationship between the control voltage value output from the processor 120 and a corresponding analogue output voltage. The control voltage value indicated in Table 1 is stored in the flash ROM 130 and invoked by the processor 120. That voltage value is then applied to the first DAC 160 or the second DAC 170. At this time, the applied control voltage value is illustrated as the values of 0 through 148. The control voltage values shown in Table 1 are merely examples for explaining an embodiment of the present invention and should not limit the invention. In Table 1, there is shown control voltage values having the values of 0 through 148, but embodiments of the present invention may have more or less values.

Preferably, the laser scanning unit 110 comprises a first laser diode 111a, a second laser diode 111b, a photodiode 112, a first diode control section 113, a second diode control section 114, a switching section 115, a laser beam detection section 116, a polygon mirror driving section 117, and EEPROM 118.

First of all, in order to match laser beam power balance between the first laser diode 111a and the second laser diode 111b, the time points of the respective laser beam power outputs are preferably known. To this end, after turning-on the first laser diode 111a, the processor 120 applies an extremely low level of control voltage information (e.g., 20 to 30) to the first DAC 160, thereby making the analogue control voltage value output from the first DAC 160 extremely low. When the laser beam LD1 is emitted from the laser diode 111a with the control voltage output from the first DAC 160, the laser beam detection section 116 detects the emission and informs the processor 120. The processor 120 sends the control voltage value sent to the first DAC 160 to a first comparator 113a. To compare the output control voltage value to the control voltage value stored on the RAM 140 at the time point of the emission of the first laser beam LD1 from the first laser diode 111a.

In this manner, the processor 120 refers to a control voltage information corresponding to a laser beam emission commence voltage previously stored on the EEPROM 118 and the control voltage value stored on the RAM 140, thereby correcting the control voltage by the difference of the control voltage output from the first DAC 160 or the second DAC 170. For instance, if the control voltage value of the laser beam emission previously stored on the EEPORM 118 is 30, and the control voltage value at the time when the first beam LD1 is emitted from the first laser diode 111a of the laser scanning unit mounted on the laser printer is 35. The processor 120 controls the first DAC 160 in order to perform a correction on the difference between the control voltage value of 30 stored on the EEPROM 118 and the detected control voltage value of 35. Of course, the above control voltage values are merely representative of the type of values that the device may use. The above values may not represent true control voltage values. The above control voltage values are for explanatory purposes only and should not limit the invention. Next, the processor 120 calculates the correction value on the first laser diode 111a, and then turns-off the first laser diode 111a and turns-on the second laser diode 111b. The process of calculating the correction value on the second laser diode 111b is the same as the process of calculating the correction value on the first laser diode 111a and will be omitted. The processor 120 calculates the correction values on the first DAC 160 and the second DAC 170 and stored the calculated correction values on RAM 140. The processor 120 applies the correction values stored on the RAM 140 and adds or subtracts the control voltage value applied to the first DAC 160 and second DAC 170.

Thereby, the optical power of the laser beams are similar when emitted from the first laser diode 111a and the second laser diode 111b to the photosensitive drum (not shown).

Given expression to this by a formula, it is as follows:
Rb′=Rb−(Ra−Ra′) <Formula 1>
wherein, the variable Rb′ denotes a control voltage value corresponding to a corrected control voltage. The variable Rb denotes a control voltage value corresponding to a control voltage applied to the laser scanning unit before the correction The variable Ra denotes a control voltage value corresponding to a laser beam power detection voltage previously stored in the laser scanning unit. The variable Ra′ denotes a control voltage value corresponding to a control voltage at the time of detecting the laser beam power emitted from the laser scanning unit after the laser scanning unit is mounted on the image forming apparatus.

The first diode control section 113 and the second diode control section 114 control the first laser diode 111a and the second laser diode 111b, respectively, so that the optical power of the laser beams emitted from the diodes 111a and 111b becomes constant.

The first diode control section 113 comprises a first comparator 113a, a first sample and hold 113b, a second comparator 113c, and a first constant current control section 113d.

The first comparator 113a compares a control voltage (serving as a reference voltage) applied from the first DAC 160 with a voltage (serving as the comparison voltage) corresponding to a current applied from the photodiode 112. Here, the current output from the photodiode 112 is transformed to a voltage value by a resistor 113e. As a result of the comparison, if the voltage applied from the first DAC 160 is high, a signal having a logic level “high” is output. The first sample and hold 113b samples and holds the signal for a given time interval. The held sampling voltage is applied to the second comparator 113c, and the second comparator 113c compares the sampled and held voltage with the voltage fedback from the current control section 113d to make the current passing through the first laser diode 111a constant. Since this circuitry is identical to a typical APC circuit that controls the laser beam power of the laser diodes 111a and 111b, respectively, the detailed description thereof will be omitted below. Also, since the operating principal of the second laser diode control section 114 is identical with that of the first laser diode control section 113, the detailed description thereof will also be omitted below.

The switching section 115 is controlled by the processor 120, and selectively connects the output current of the photodiode 112 to the first laser diode control section 113 or the second laser diode control section 114 when the processor 120 controls the laser beam power balance between the first laser diode 111a and the second laser diode 111b.

The EEPROM 118 has, before the laser scanning unit 110 is mounted on the image forming apparatus, the value of the control voltages applied to the laser diodes 111a and 111b at the time points of the emissions of the first laser beam LD1 and the second laser beam LD2 and the previously stored value of the control voltages applied to the laser diodes 111a and 111b at the time the output of the laser beam emitted from the laser scanning unit 110 reaches a prescribed level (for example, 400 μW).

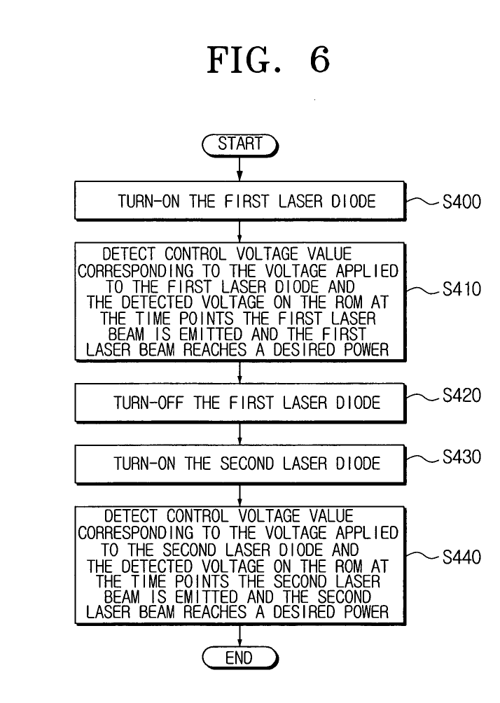

FIG. 6 is a flowchart of a preferred embodiment of a method for controlling laser beam power balance in the laser scanning unit according to an embodiment of the present invention.

The present embodiment shows the step of recording the electric characteristic previously stored in the laser scanning unit 110 (the laser beam emission commence voltage, and the laser diode control voltage value at the time the laser beam reaches a desired optical power).

First referring back to FIG. 2, the laser scanning unit 110 carried on the conveyor belt 300 is supplied with power. While not shown in the drawing, when testing the laser scanning unit 110, a testing unit (not shown) for supplying a control signal to the laser scanning unit 110 is included in the proximity of the conveyor belt 300 in order to confirm a basic operation of the laser scanning unit 110. Since the testing unit is included in a general factory that tests and assembles the electronic articles, the description thereof will be omitted. Now referring to FIG. 6, the first laser diode 111a is turned-on using the testing unit (not shown) (S400). Subsequently, the testing unit sequentially applies a predetermined voltage (for example, 0.1V to 1V) to the first laser diode 111a. The first laser diode 111a emits the first laser beam LD1 in response to the voltage sequentially applied, and the laser beam detection section 116 included in the laser scanning unit 110 detects the emission and informs the testing unit of it. The testing unit has the control voltage value corresponding to the control voltage at the time of detecting the first laser beam LD1 by the laser detection section 116 stored on the EEPROM 118 included in the laser scanning unit 110 (S410). Subsequently, the testing unit turns-off the first laser diode 111a (S420) and turns-on the second diode 111b (S430). Finally, the testing unit sequentially applies a predetermined voltage (for example, 0.1V to 1V) to the second laser diode 111b. The second laser diode 111b emits the second laser beam LD2 in response to the voltage sequentially applied, and the laser beam detection section 116 included in the laser scanning unit 110 detects the emission and informs the testing unit of it. The testing unit has a control voltage value corresponding to a control voltage at the time of detecting the second laser beam LD2 by the laser detection section 116 stored on the EEPROM 118 included in the laser scanning unit 110 (S440). According to this, the laser scanning unit 110 tested by the conveyor belt 300 has stored within it the values of the laser beam emission commence voltages of the first laser diode 111a and the second laser diode 111b, and the values of the control voltage applied to the laser diode when reaching a target optical power.

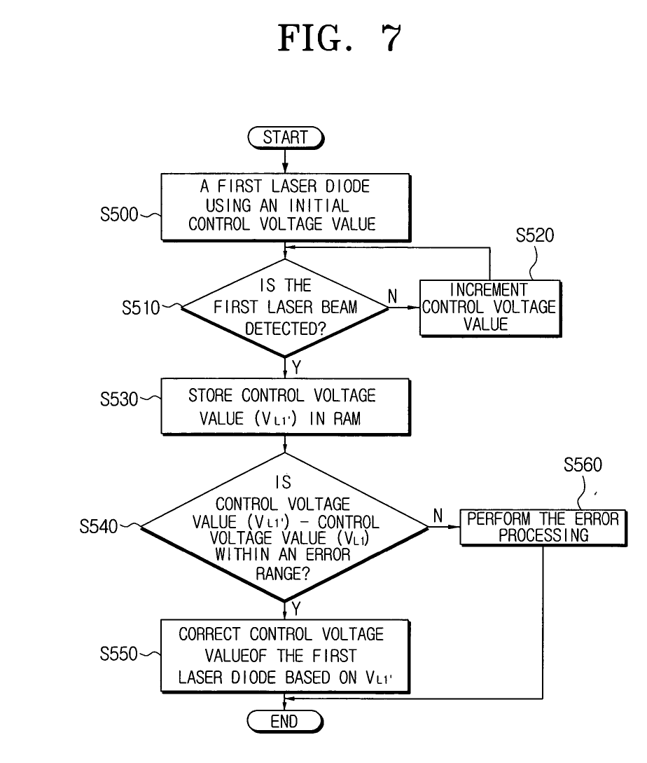

FIG. 7 is a flowchart illustrating a method for controlling the laser beam power balance between a first laser diode and a second laser diode included in a laser scanning unit having a value of an emission commence voltage which is mounted on an image forming apparatus according to an embodiment of the present invention.

First of all, the processor 120 controls the first DAC 160 and gradually increases the voltage output from the first DAC 160 from an extremely low voltage (for example, 0V) (S500). When the laser diode control section 113 scans, in response to the control voltage output from the first DAC 160, the laser beam LD1 onto the photosensitive drum (not shown), the laser beam detection section 116 detects such a scan and informs the processor 120 (S510). The processor 120 recognizes the control voltage value of the first DAC 160 according to the detection time point of the laser beam detection section 116 as the control voltage value on the first laser beam emission commence voltage of the first laser diode 111a, and has the recognized control voltage value stored on the RAM 140 (S530). If the laser beam detection section 116 does not detect the first laser beam LD1 from the first laser diode 111a, the processor 120 gradually increases the control voltage value to the first DAC 160 until the laser beam detection section 116 detects the laser beam LD1 (S520).

Next, the processor 120 compares the control voltage value (V_{L1}′) stored on the RAM 140 and the control voltage value on the emission commence voltage (V_{L1}) of the laser scanning unit measured under the condition the laser scanning unit is mounted on the image forming apparatus, thereby obtaining that variation. If the obtained variation falls within a predetermined range (for example, 5 to 10), the processor 120 recognizes the obtained variation as being in the normal error range to reflect the obtained variation (S550); otherwise (for example, the variation is above 30), the processor 120 carries out the error processing (S560). For instance, in a case that the control voltage value stored on the RAM 140 is 35 and the control voltage value stored on the EEPROM 118 is 30, the processor 120 reflects the variation value 5 and decreases the voltage value output from the first DAC 160 when driving the first DAC 160, thus limiting the optical power of the laser beam LD1 emitted from the first laser diode 111a. The error processing step (S560) may output a given message via a display device (for example, LED or LCD) included in the image forming apparatus, or generate a beep or other audible signal. After the correction on the first laser diode 111a is terminated, the first laser diode 111a is turned-off and the above steps (S500 to S560) may be applied to the second laser diode 111b. However, since similar steps are followed for correcting the second laser diode 111b as for first laser diode 111a, the description thereof will be omitted.

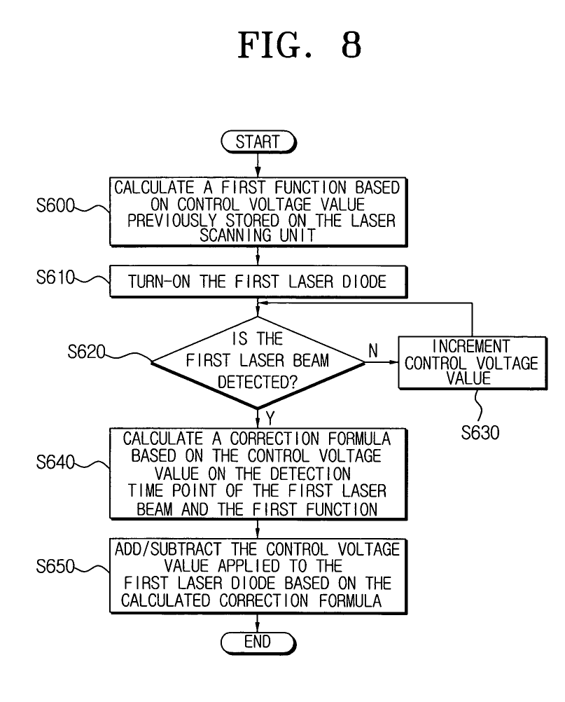

FIG. 8 is a flowchart illustrating another method for controlling the laser beam power balance between a first laser diode and a second laser diode included in a laser scanning unit having the information on an emission commence voltage which is mounted on an image forming apparatus.

At first, the processor 120 calculates a first function, based on the emission commence voltage of the first laser beam LD1 emitted from the first laser diode 111a previously stored in the laser scanning unit 110 and the control voltage information on a voltage applied to the first laser diode 111a when the first laser beam LD1 emitted from the first laser diode 111a reaches a given level (such as, 400 μW) (S600). Similarly, the processor 120 calculates a second function for controlling the second laser diode 111b through the same process as the first calculating process. Then, the processor 120 turns-on the first laser diode 111a (S610), and then controls the first DAC 160 by gradually increasing the control voltage value, thereby gradually increasing the voltage output from the first DAC 160 from an extremely low voltage (for instance, 0.1V). When the first laser diode 111a scans the first laser beam LD1 on the photosensitive drum (not shown) with the control voltage output from the first DAC 160, the laser beam detection section 116 detects such a scan and informs the processor 120 (S620). The processor 120 recognizes the control voltage of the first DAC 160 according to the detection time point of the laser beam detection section 116 as a laser beam emission commence voltage of the first laser diode 111a and has the corresponding control voltage information stored on the RAM 140. If the laser beam detection section 116 does not detect the first laser beam LD1 from the first laser diode 111a, the processor 120 controls the first DAC 160 to gradually increase the control voltage applied to the first laser diode 111a until the laser beam detection section 116 detects the first laser beam LD1 (S630). Then, the processor 120 calculates a correction formula, based on the control voltage value on the laser beam commence voltage of the first laser diode 111a and a first function (S640). An exemplary function is as follows below:

ti Rb′=Rb+f(Ra, Ra′) <Formula 2>

wherein, the variable Rb′ denotes a control voltage value corresponding to a corrected control voltage The variable Rb denotes a control voltage value corresponding to a control voltage applied to the laser scanning unit before the correction. The variable Ra denotes a control voltage value corresponding to a laser beam power detection voltage previously stored in the laser scanning unit. The variable Ra′ denotes a control voltage value corresponding to a control voltage at the time of detecting the laser beam power emitted from the laser scanning unit after the laser scanning unit is mounted on the image forming apparatus. Finally, the function f(Ra, Ra′) denotes a function calculated based on a first voltage value and a third voltage value, or a function calculated based on a second voltage value and a fourth voltage value.

Finally, based on the correction formula calculated by Formula 2, the processor 120 adds or subtracts the control voltage value applied to the first DAC 160, thereby adding or subtracting from the voltage applied to the first laser diode 111a from the first DAC 160 (S650). Since this process step is similarly applied to the second laser diode 111b, the description thereof will be omitted.

In accordance with the method described above, it is possible to constantly maintain the laser beam power balance between the laser diodes according to the respective electrical characteristics of the laser scanning unit 110 and the respective characteristics of the image forming apparatus that occur after the laser scanning unit is mounted on the image forming apparatus.

As noted above, embodiments of the present invention can accurately and automatically control the optical power balance between the laser beams emitted from the laser scanning unit that emits a single beam or multi-beams, and does not require separate hardware. Further, it takes less time to control the optical power balance between the laser beams as compared to the conventional manual control method.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A method for controlling laser beam power balance in a laser scanning unit comprising the steps of:
obtaining a first voltage value corresponding to a detection time point of the laser beam power emitted from the laser scanning unit and recording the first voltage value to the laser scanning unit;
mounting the laser scanning unit on an image forming apparatus;
obtaining a second voltage value corresponding to the detection time point of the laser beam power emitted from the laser scanning unit by driving the laser scanning unit mounted on the image forming apparatus and comparing the second voltage value with the first voltage value; and
correcting the control voltage controlling the laser scanning unit by that variation.

2. The method of claim 1, wherein the step of correcting the control voltage of the laser scanning unit is carried out by the following formula:
Rb′=Rb−(Ra−Ra′)
wherein, Rb′ denotes a corrected control voltage, Rb denotes a control voltage applied to the laser scanning unit before the correction, Ra denotes a laser beam power detection voltage previously stored in the laser scanning unit, and Ra′ denotes a control voltage at the time of detecting the laser beam power emitted from the laser scanning unit after the laser scanning unit is mounted on the image forming apparatus.

3. The method of claim 1, wherein the step of correcting the control voltage of the laser scanning unit further comprises the step of processing an error when a difference between the first voltage value and the second voltage value exceeds a predetermined error range.

4. A method for controlling a laser beam power balance in a laser scanning unit comprising the steps of:
obtaining a first voltage value and a second voltage value corresponding to detection time points of a first laser beam and a second laser beam, respectively, emitted from the laser scanning unit and recording the first voltage value and the second voltage value to the laser scanning unit;
mounting the laser scanning unit on a image forming apparatus;
obtaining a third voltage value and a fourth voltage value corresponding to the detection time points of the first laser beam and the second laser beam, respectively, emitted from the laser scanning unit by driving the laser scanning unit mounted on the image forming apparatus; and
comparing the third voltage value and the fourth voltage value with the first voltage value and the second voltage value, respectively, thereby correcting the control voltage controlling the laser scanning unit by that variation.

5. The method of claim 4, wherein the step of correcting the control voltage of the laser scanning unit is carried out by the following formula:
Rb′=Rb−(Ra−Ra′)
wherein, Rb′ denotes a corrected control voltage, Rb denotes a control voltage applied to the laser scanning unit before the correction, Ra denotes a laser beam power detection voltage previously stored in the laser scanning unit, and Ra′ denotes a control voltage at the time of detecting the laser beam power emitted from a laser scanning unit after the laser scanning unit is mounted on the image forming apparatus.

6. The method of claim 4, wherein the step of correcting the control voltage of the laser scanning unit further comprises the step of processing errors when a difference between the first voltage value and the third voltage value and a difference between the second voltage value and the fourth voltage value exceed a predetermined error range.

7. A method for controlling a laser beam power balance in a laser scanning unit comprising the steps of:
obtaining a first voltage value and a second voltage value corresponding to detection time points of a first laser beam and a second laser beam, respectively, emitted from the laser scanning unit;
obtaining a third voltage value and a fourth voltage value corresponding to time points the first laser beam and the second laser beam reach a target laser beam power, and recording these voltage values in the laser scanning unit;
mounting the laser scanning unit on a image forming apparatus;
calculating a first function having a prescribed gradient based on the obtained first and second voltage values, and a second function having a prescribed gradient based on the obtained third and fourth voltage values; and
setting as an initial value the voltage values corresponding to the detection time points of the respective laser beams emitted from the laser scanning unit mounted on the image forming apparatus, thereby applying the first function and the second function.

8. The method of claim 7, wherein the step of applying the first function and the second function is carried out by formula below:
Rb′=Rb+f(Ra, Ra′)
wherein, Rb′ denotes a corrected control voltage, Rb denotes a control voltage applied to the laser scanning unit before the correction, Ra denotes a laser beam power detection voltage previously stored in the laser scanning unit, Ra′ denotes a control voltage at the time of detecting the laser beam power emitted from a laser scanning unit after the laser scanning unit is mounted on the image forming apparatus, and f(Ra, Ra′) denotes a function calculated based on the first voltage value and the third voltage value or a function calculated based on the second voltage value and the fourth voltage value.
